(19) United States
(12) Patent Application Publication
(10) Pub. No.: US 2026/0004490 A1
(43) Pub. Date: Jan. 1, 2026

(54) Feedback Predictions for Machine-Learned Generative Models

(71) Applicant: Google LLC, Mountain View, CA (US)

(72) Inventors: Junfeng He, Fremont, CA (US); Youwei Liang, San Diego, CA (US); Gang Li, Santa Clara, CA (US); Feng Yang, Sunnyvale, CA (US); Junjie Ke, San Jose, CA (US); Peizhao Li, Bellevue, WA (US); Vidhya Navalpakkam, Santa Clara, CA (US); Jiao Sun, Sunnyvale, CA (US); Yang Li, Palo Alto, CA (US); Kai Jochen Kohlhoff, Mountain View, CA (US); Jordi Pont-Tuset, Zurich (CH); Deepak Ramachandran, Sunnyvale, CA (US)

(21) Appl. No.: 19/251,372

(22) Filed: Jun. 26, 2025

Related U.S. Application Data
(60) Provisional application No. 63/664,586, filed on Jun. 26, 2024.

(51) Int. Cl. G06T 11/60; G06T 5/60; G06T 5/77

(52) U.S. Cl. CPC G06T 11/60; G06T 5/60; G06T 5/77; G06T 2207/20081; G06T 2207/20084

(57) ABSTRACT

Aspects of the disclosed technology include computer-implemented systems and methods for machine-learned multimodal models for feedback predictions for synthetic content. A machine-learned multimodal model is configured to generate a feature map based at least in part on fusion of image information and text information from a synthetic image and a text prompt. The model is configured to generate a set of text tokens based at least in part on fusion of the image information and the text information. The model is configured to generate at least one misalignment or implausibility heatmap based at least in part on the at least one feature map. The model is configured to generate at least one predicted misalignment sequence based at least in part on the set of text tokens.

### PRIORITY CLAIM

The present application claims priority to U.S. Patent Application No. 63/664,586, entitled “Feedback Predictions for Machine-Learned Generative Models,” having a filing date of Jun. 26, 2024, which is incorporated by reference herein.

### FIELD

The present disclosure relates generally to machine learning processes and machine-learned devices and systems. More particularly, the present disclosure relates to machine-learned generative models and feedback predictions for synthetically generated visual content.

### BACKGROUND

Artificial intelligence systems increasingly include large foundational machine-learned models which have the capability to provide a wide range of new product experiences. Machine-learned models such as generative models, for example, demonstrate remarkable language-image capabilities including the ability to generate or synthesize new images based on textual inputs and the ability to generate textual responses based on image inputs. Machine-learned models are also capable of modeling human behavior, such as human attention and subject ratings/preferences relative to visual content. There has been progress in building machine-learned models for generating evaluations such as metrics for synthetic content created by generative models. Current technologies, however, focus on modeling single-score metrics or provide expensive and complex models that are unable to predict fine-grained or localized feedback.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method that includes, by a computing system including one or more computing devices, obtaining a text prompt and a synthetic image generated by a machine-learned generative model in response to the text prompt, generating, with a machine-learned multimodal model, at least one feature map based at least in part on fusion of image information and text information from the synthetic image and the text prompt, generating, with the machine-learned multimodal model, a set of text tokens based at least in part on fusion of the image information and the text information, generating, with the machine-learned multimodal model, at least one image heatmap based at least in part on the at least one feature map, and generating, with the machine-learned multimodal model, at least one predicted misalignment sequence based at least in part on the set of text tokens.

Another example aspect of the present disclosure is directed to a system including one or more processors, and one or more computer-readable storage media that store instructions that, when executed by the one or more processors, cause the one or more processors to perform operations that include obtaining a text prompt and a synthetic image generated by a machine-learned generative model in response to the text prompt, generating, with a machine-learned multimodal model, at least one feature map based at least in part on fusion of image information and text information from the synthetic image and the text prompt, generating, with the machine-learned multimodal model, a set of text tokens based at least in part on fusion of the image information and the text information, generating, with the machine-learned multimodal model, at least one image heatmap based at least in part on the at least one feature map, and generating, with the machine-learned multimodal model, at least one predicted misalignment sequence based at least in part on the set of text tokens.

Another example aspect of the present disclosure is directed to one or more non-transitory computer-readable storage media that store instructions that, when executed by one or more processors, cause the one or more processors to perform operations that include obtaining a text prompt and a synthetic image generated by a machine-learned generative model in response to the text prompt, generating, with a machine-learned multimodal model, at least one feature map based at least in part on fusion of image information and text information from the synthetic image and the text prompt, generating, with the machine-learned multimodal model, a set of text tokens based at least in part on fusion of the image information and the text information, generating, with the machine-learned multimodal model, at least one image heatmap based at least in part on the at least one feature map, and generating, with the machine-learned multimodal model, at least one predicted misalignment sequence based at least in part on the set of text tokens.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram depicting an example computing environment including a machine-learned multimodal model for feedback predictions for visual content according to example embodiments of the present disclosure;

FIG. 2 is a block diagram depicting an example computing environment including a machine-learned multimodal model for feedback predictions for visual content according to example embodiments of the present disclosure;

FIG. 3 is a block diagram depicting an example computing environment including a user interface for generating rich human feedback data for synthetically generated images according to example embodiments of the present disclosure;

FIG. 4 is a flowchart diagram depicting an example method for generating feedback predictions with a machine-learned multimodal model according to example embodiments of the present disclosure;

FIG. 5 is a flowchart diagram depicting an example method for generating feedback predictions with a machine-learned multimodal model and training a machine-learned generative model using the feedback predictions according to example embodiments of the present disclosure;

FIG. 6 is a flowchart diagram depicting an example method for generating feedback predictions with a machine-learned multimodal model and performing region inpainting on synthetic images based on the feedback predictions according to example embodiments of the present disclosure;

FIG. 7 is a flow chart diagram illustrating an example method for training a machine-learned model according to example implementations of aspects of the present disclosure;

FIG. 8 is a block diagram of an example processing flow for using machine-learned model(s) to process input(s) to generate output(s) according to example embodiments of the present disclosure;

FIG. 9 is a block diagram of an example sequence processing model according to example embodiments of the present disclosure;

FIG. 10 is a block diagram of an example technique for populating an example input sequence for processing by a sequence processing model according to example embodiments of the present disclosure;

FIG. 11 is a block diagram of an example model development platform according to example embodiments of the present disclosure;

FIG. 12 is a block diagram of an example training workflow for training a machine-learned model according to example embodiments of the present disclosure;

FIG. 13 is a block diagram of an inference system for operating one or more machine-learned model(s) to perform inference according to example embodiments of the present disclosure;

FIG. 14 is a block diagram of an example networked computing system according to example embodiments of the present disclosure;

FIG. 15 is a block diagram of an example computing device according to example embodiments of the present disclosure; and

FIG. 16 is a block diagram of an example computing device according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Generally, the present disclosure is directed to machine-learning systems and methods for predicting feedback for visual content created by machine-learned generative models such as text-to-image models. More particularly, the present disclosure is directed to machine-learning systems including models that can automatically generate feedback which can be leveraged to improve image generation by generative models. For example, the automatically generated feedback can be used to finetune and improve the generative models and/or to generate masks or other data for inpainting problematic regions in generated images. In accordance with example embodiments, rich human feedback can be used as training data to train a machine-learned multimodal model to generate feedback predictions for synthetic content. The rich human feedback can include annotations for synthetically generated images, including notations of image regions that are implausible or misaligned with the input text and notations of words in the input text that are misrepresented or missing in the image. The rich human feedback can also include scores for plausibility, text-image alignment, aesthetics, and overall quality. In an example embodiment, a multimodal transformer can be trained using this training data to predict rich human feedback automatically. Notably, the disclosed techniques are generalizable and transferrable, with the improvements generalizing to models beyond those used to generate the images on which the human feedback is collected.

Machine-learned text-to-image generative models such as a Stable Diffusion and Imagen have made significant progress in generating high-resolution images based on text descriptions. The images or other content created by a machine-learned generative model may be referred to as synthetic content. Despite this progress, many synthetic images still suffer from issues such as artifacts/implausibility, misalignment with text descriptions, and low aesthetic quality. For example, these models often generate images with distorted human/animal bodies (e.g., human hands with more than five fingers), distorted objects and implausibility issues (e.g., a floating lamp). Similarly, text-image misalignment issues are common. For example, a text prompt “a man jumping into a river” may result in an image of a man standing.

While evaluation metrics have been proposed for synthetic images, current technologies compute these over distributions of images and may not reflect the nuances in individual images. Reinforcement learning with human feedback (RLHF) has been used to improve these systems by collecting human-provided scores as feedback on the synthetically generated images and training a reward model to improve the text-to-image generation. Recent research has focused on collecting human preferences/ratings to evaluate the quality of generated images and training evaluation models to predict those ratings. While more focused, these efforts summarize the quality of an image into a single score. Other research has also provided single-score metrics for prompt-image alignment. While some more calibrated and explainable techniques have been proposed, they use expensive and complex models that are unable to generate fine-grained or localized predictions such as localized regions of misalignment. For example, systems have been proposed that collect human rankings and ratings of images based on quality and then train a reward model for human preference learning. Reward feedback learning (ReFL) has been proposed for tuning diffusion models with the image reward model. Another approach collects human preferences as the selection of the “better” image amongst pairs of images to generate a dataset which is used to train a text-to-image model to generate a score for predicting human preferences. Other techniques utilize human preferences to train a classifier to output a human preference score or collect artifact data to train a segmentation model to predict artifact regions. These existing proposals focus on binary human ratings or preference ranking for construction of feedback/rewards, and lack the ability to provide detailed actionable feedback.

In accordance with example embodiments of the present disclosure, a machine-learned multimodal model is configured to provide fine-grained multi-faceted evaluations of synthetically generated content such as images created by an image-to-text model. The evaluations are interpretable and attributable (e.g., to regions with artifacts/implausibility or image-text misalignments) which provide a fuller understanding of image quality than single scalar scores. A machine-learned system according to example implementations can include a multimodal transformer model that is trained to predict rich human annotations on synthetically generated images and the text prompt used to create the image. The model can predict implausibility and misalignment regions, misaligned sequences (e.g., keywords), and fine-grained scores. The model not only provides reliable ratings, but also more detailed and explainable insights about the quality of generated images. The model provides an automatic and explainable pipeline to evaluate text-to-image generation by text-to-image generation models.

According to example aspects of the present disclosure, a multimodal model for evaluating synthetically generated content can be trained using rich human feedback on images. The rich human feedback can include: point annotations on the image that highlight regions of implausibility/artifacts, and text-image misalignment; labeled words on the prompts specifying the missing or misrepresented concepts in the generated image; and/or fine-grained scores for image plausibility, text-image misalignment, etc. The model can include one or more predictors such as prediction heads to generate feedback outputs. The model can include one or more heatmap prediction heads configured to generate one or more heatmaps such as an implausibility heatmap identifying implausible regions within an image and/or a misalignment heatmap identifying misaligned regions within an image. The model can also include one or more sequence alignment heads configured to generate misaligned sequence predictions indicating portions (e.g., words) of a text prompt that are misaligned with the synthetic image. The model can also include one or more rating heads configured to generate one or more fine-grained image scores such as a plausibility score, an alignment score, an aesthetics score, and/or an overall score. The model can receive an input including an imagery input and a text input and generate one or more image evaluations based on the inputs. In example embodiments, the imagery can include a synthetic image generated by a machine-learned generative model in response to the text input.

According to an example aspect of the present disclosure, a machine-learned multimodal model is provided that is configured to receive as input both imagery and text. Input imagery can include data representative of one or more images, videos, or other visual data. Input text can include data representative of one or more instructions, queries, or other textual data such as a text prompt that was used to generate the input imagery. The input imagery can include synthetic imagery generated by a machine-learned generative model in response to a prompt including the input text.

In accordance with an example embodiment of the present disclosure, the multimodal model includes a multimodal encoder-decoder transformer model. The model can include one or more embedding layers configured to receive imagery and text and generate image tokens and image tokens. The embedding layers can include image embedding layer(s) (e.g., a vision transformer) and text embedding layer(s) (e.g., a word embedding layer). The model can include a self-attention transformer encoder to fuse image and text representations. The text information can be propagated to image tokens for a text misalignment score and heatmap prediction. The vision information can be propagated to text tokens for better vision-aware text encoding to decode the text misalignment sequence. The model can include one or more predictors configured to generate feedback predictions based on the input imagery and text.

In accordance with an example of the present disclosure, a machine learned model can include a multimodal encoder-decoder transformer model to unify the various modeling tasks. The model can be configured to receive two types of inputs including an image input and a text prompt. The model can include one or more image or visual embedding layers (e.g., a vision transformer model for image encoding), one or more text embedding layers for text embedding (e.g., to embed text tokens), and a transformer self-attention encoder to fuse image and text representations. The visual embedding layers can receive a synthetic image as input and generate an output including image tokens as high-level representations. The image tokens can be reshaped into feature maps. The text embedding layers can receive a text prompt as input and generate an output including text prompt tokens which are embedded into dense vectors. The transformer self-attention encoder can concatenate and encode the image tokens and the embedded text tokens.

Additionally, the model can include a plurality of predictors such as three different predictors (e.g., separate prediction heads) including a heatmap predictor (e.g., heatmap prediction head) for implausibility heatmaps or misalignment heatmaps, a sequence predictor (e.g., sequence prediction head) for predicting misaligned keyword sequences, and a rating predictor (e.g., rating prediction head) for plausibility, alignment, aesthetics, and/or overall scores of images.

The heatmap predictor can include one or more convolution layers and one or more deconvolution layers. For heatmap predictions, the image tokens can be reshaped into a feature map and sent through convolution layers, deconvolution layers, and sigmoid activation. A heatmap can include a predicted probability distribution of implausibility or misalignment over an input image. The heatmap predictor can include a heatmap prediction head that receives fused image tokens or a feature map after the transformer encoder, and processes the features via one or more read-out convolution layers, together with up-sampling so that the output matches the resolution of the input image. A sigmoid function can be used at the end to ensure the generated values fall within a specified range (e.g., [0,1]) for each pixel. The heatmap predictor can output implausibility and/or misalignment heatmaps.

The rating predictor can include one or more convolution layers and one or more linear layers. The feature map can be sent through the convolution layers, the linear layers, and sigmoid activation. The rating predictor can generate an output including scalars as fine-grained scores for plausibility, alignment, aesthetics, and/or overall image quality.

The sequence predictor can include a transformer self-attention decoder. To predict a keyword misalignment sequence, the original prompt used to generate the synthetic image can be used as text input to the model. A modified prompt can be used as the prediction target for the decoder. The modified prompt can include a special suffix (e.g., ‘_0’) for each misaligned token. For example, a yellow_0 cat can be used if the generated image contains a black cat and the word yellow is misaligned with the image. During evaluation, the misaligned keywords can be extracted using the special suffix.

According to an example aspect of the present disclosure, the unified model can include a backbone model that is trained using large-scale web page data, mobile interface data, and/or natural image captioning datasets. The model and pretraining datasets can be constructed to suit image prediction tasks. For example, natural image captioning datasets can be used to pretrain the model.

The number and type of predictors for the machine-learned feedback prediction model can vary. In accordance with an example embodiment of the present disclosure, a respective model prediction head is provided for each model prediction type including each prediction score type, each heatmap type, and each misaligned keyword sequence type. For heatmap generation, for example, a first prediction head can be provided to generate implausibility heatmaps and a second prediction head can be provided to generate misalignment heatmaps. For rating or score generation, a first prediction head can be used to generate an alignment score, a second prediction head can be used to generate a plausibility score, a third prediction head can be used to generate an aesthetics score, and a fourth prediction head can be used to generate an overall image quality score. For the keyword misalignment sequence, a single decoder can be used to predict keyword misalignments.

In accordance with another example embodiment, a single model prediction head can be used to generate different prediction types. A first model prediction head can be used to generate different heatmap prediction types, a second model prediction head can be used to generate different score types, and a third model prediction head can be used to generate misalignment sequences. An input prompt can be augmented with the prediction output type to cause the model prediction head to generate a particular prediction. A task string can be prepended to an input text prompt for each particular task. The corresponding label can be used as a training target. During inference, by augmenting the prompt with the corresponding task string, a single prediction head can generate different prediction types. For example, the task string “implausibility heatmap” can be prepended to an input prompt to cause the heatmap prediction head to generate an implausibility heatmap. The task string “alignment score” can be prepended to an input prompt to cause the rating prediction head to generate an alignment score. In this manner, an augmented prompt approach can create task-specific vision feature maps and text encodings.

In accordance with example embodiments of the present disclosure, a multimodal feedback prediction model can be used to improve image generation. According to one example aspect, one or more outputs of the multimodal feedback prediction model can be used to finetune generative models. Notably, the described techniques are generalizable such that the outputs of the multimodal feedback prediction model can be used to train a generative model that is different from the generative model that was used to generate the synthetic images on which the multimodal model was trained.

In one example, a set of training data can be generated by selecting or filtering images based on the output of the multimodal feedback prediction model. For example, a set of images can be generated for each of one or more text prompts. For instance, eight images can be generated in response to a prompt. The images can be generated using a target model that is to be trained. The target model can be different than the model that generated the original images on which the multimodal feedback prediction model was trained. The multimodal feedback prediction model can then be used to generate a heatmap, feedback score(s), and/or a misaligned keyword sequence output for each image. The system can select images for a finetuning dataset based on the output of the prediction model. For example, the system can obtain one or more scores generated for an image. If the score(s) generated for an image satisfies one or more criteria (e.g., exceeds a fixed threshold), the image and corresponding prompt can be selected as part of the finetuning dataset. The target generative model can then be trained using the finetuning dataset.

According to another example aspect, one or more outputs of the multimodal model can be used to perform region inpainting to directly improve image generation. For example, the multimodal model feedback prediction model can generate an implausibility heatmap for an image. The system can obtain the heatmap and process the heatmap using thresholding and dilating to create a mask. The mask can then be used to inpaint within the masked region(s) to generate one or more new images that better match the input prompt. In an example embodiment, an image generation model can obtain the mask and perform inpainting on the masked regions.

According to an example aspect of the present disclosure, a machine-learned multimodal feedback prediction model can be trained using rich human feedback including annotations of synthetic images created by a generative model in response to an input text prompt. In an example implementation, the rich human feedback can include, for each synthetic image and prompt pair, an artifact/implausibility heatmap, a misalignment heatmap, a plausibility score, an alignment score, an aesthetics sore, an overall score, and one text sequence (misaligned keywords). A user interface such as a web-based interface can be provided in an example embodiment to collect rich human feedback and generate feedback training data. The interface can display a synthetic image and a prompt that was used to generate the synthetic image. The interface can also display a panel that facilitates the receipt of inputs from annotators. For example, the interface can enable an annotator to indicate points or locations in the image that contain implausibility/artifact regions. Similarly, the interface can enable an annotator to indicate points or locations in the image that contain misalignments with respect to the input text prompt. Each marked point can have an effective radius (e.g., 1/20th of the image height) which forms an imaginary disk centered at the marked point. In this manner, a relatively small amount of points can be used to cover the image region with flaws. The interface can also enable an annotator to label misaligned keywords in the input text prompt. Additionally, the interface can enable an annotator to provide a plausibility score, an image-text alignment score, an aesthetic score, and an overall quality score. For example, a scale of 1-5 can be used.

In accordance with an example implementation, parameters for image ratings can be established. An artifact or implausibility can be defined to include a distorted body or face of a human or animal (unless specified in the input prompt) or a missing or additional body part (unless specified in the input prompt). An artifact or implausibility can include a distorted object (non human or animal) such as furniture, vehicles, buildings (unless specified in the input prompt). An artifact or implausibility can include distorted or nonsensical text such as text that is distorted, nonsensical, or misspelled (unless specified in the input prompt), or nonsensical representations such as representations that are unrealistic/nonsensical (unless specified in the input prompt), or difficult to understand. An artifact or implausibility can include excessive blurriness or a lack of sharpness such as where the image contains excessive blurriness or quality that detracts from the overall image (a focus on one part of the image is acceptable), or where the image contains a lack of definition/sharpness that detracts from the overall image. Additional or fewer artifacts or implausibilities can be established.

A text-to-image misalignment can be defined to include something missing such as a human/animal/object specified in the text caption that is missing in the image. A text-to-image misalignment can include incorrect attributes such as an attribute (e.g., color) of an object specified in the text that is incorrect in the image, incorrect actions such as an action specified in the text caption that is not represented in the image, incorrect numbers such as counts of humans/animals/objects in the image that do not match those specified in the text, incorrect positions such as the spatial position of two entities in the image that do not match that specified in the text, or any other inconsistency between the text and the image.

Systems and methods in accordance with example embodiments of the present disclosure provide a number of technical effects and benefits. In particular, the systems and methods can include a computing system including a machine-learned system having a machine-learned multimodal feedback prediction model that is configured to generate feedback predictions for synthetically generated images. The model can include a multimodal transformer and distinct prediction heads to enable predictions including misalignment and implausibility heatmaps as well as misaligned keyword sequences. The prediction heads can further enable predictions of plausibility, alignment, aesthetics, and/or overall image scores.

Traditional machine-learned approaches for evaluating synthetic visual content have included models trained on and capable of generating binary human ratings or preference rankings. Such models lack the ability to provide detailed actionable feedback such as implausibility regions of an image, misaligned region, or misaligned keywords on synthetic images. More calibrated and explainable approaches have resulted in expensive and complex models that are unable to localize regions of misalignments in images.to finetune generative models such as text-to-image models and/or as an input to a generative model for inpainting problematic image regions.

As a technical effect and benefit, a single model capable of feedback predictions provides savings of computing resources, including storage requirements, power requirements, and processing, requirements. A single model can receive a text input and image input and generate multiple feedback predictions that can be used for finetuning, image inpainting, or other uses. Traditional modeling approaches lead to increased memory requirements, power requirements, processing requirements, and bandwidth requirements to provide model-based services over networks. Embodiments in accordance with the present disclosure provide a reduced memory footprint and processing capacity by leveraging a single model that is trained on rich human feedback data to provide multiple image feedback predictions.

In example implementations, a machine-learned multimodal feedback prediction model can include a generative model such as an image-to-text model. An image-to-text model may include a multimodal large language model (MMLLM). Much of the following disclosure refers to image-to-text models as specific examples of sequence processing models but it will be appreciated that the disclosure is equally applicable to any type of sequence processing model. For example, the disclosed technology can be used with large image models, multimodal models, and other types of foundational models. For instance, the sequence processing models can operate in domains including text domains, image domains, audio domains, biochemical domains, etc. For instance, a sequence processing model may be used to process sequential inputs for robotic controls and other tasks. Similarly, a core model and/or downstream applications can be configured to perform any number of tasks. For instance, if the inputs to the core model and/or a downstream application are images or features that have been extracted from images, the output generated by the core model and/or the downstream application for a given image can be scores for each of a set of object categories, with each score representing an estimated likelihood that the image contains an image of an object belonging to the category. As another example, if the inputs to the core model and/or a downstream application are sensor data, the outputs can be robotic control signals.

A machine-learned multimodal model in accordance with example embodiments, can include various types of generative models. In an example, a generative model can include a sequence processing model, such as a large image-language model including 10B parameters or more. In another example, a multimodal model can include an image-language model having less than 10B parameters (e.g., 1B parameters). In yet another example, the multimodal model can include an autoregressive language model or an image diffusion model.

As further examples, a generative model can include a machine-learned text-to-image model, a machine-learned text-to-video model, a machine-learned text-to-audio model, a machine-learned multi-modal model, or any other machine-learned model configured to provide generative content in response to a user query. The generative content generated by generative models can include computer-executable code data, text data, image data, video data, audio data, or other types of generative content. The generative model can be trained to process input data to generate output data. The input data can include text data, image data, audio data, latent encoding data, and/or other input data, which may include multimodal data. The output data can include computer-executable code data, text data, image data, audio data, latent encoding data, and/or other input data.

As another example, if the input to the core model and/or a downstream application is a sequence representing a spoken utterance, the output generated can be a score for each of a set of pieces of text, each score representing an estimated likelihood that the piece of text is the correct transcript for the utterance.

As another example, if the input to the core model and/or a downstream application is a sequence of physiological measurements, the output generated may be a score for each of a set of possible diagnoses for the condition of a user, with the score representing an estimated likelihood that the diagnosis is accurate.

As another example, if the input to the core model and/or a downstream application is a sequence of text from a received communication, the output generated may be a score for each of a set of possible responses to the received communication, with the score representing an estimated likelihood that the response matches a user's intent.

As another example, if the input to the core model and/or a downstream application is indicative of a particular function to be performed by an apparatus (such as a robot), the output generated may be a score for each of a set of possible control signals for controlling the apparatus, with the score representing an estimated likelihood that the control signals match the particular function to be performed.

As another example, if the input to the core model and/or a downstream application includes natural language indicative of a computer implemented operation, the output generated may be a score for each of a set of possible computer readable code segments, with the score representing an estimated likelihood that the computer readable code segments match the computer implemented operation.

As another example, if the input to the core model and/or a downstream application is a sequence of text in one language, the output generated may be a score for each of a set of pieces of text in another language, with each score representing an estimated likelihood that the piece of text in the other language is a proper translation of the input text into the other language.

Although a number of examples of tasks which may be performed by the core model and/or a downstream application are provided here, it will be understood that this is not exhaustive, and that the core model and/or the downstream applications can be configured to perform any suitable task.

With reference now to the Figures, example embodiments of the present disclosure will be discussed in further detail.

### Example Model Arrangements

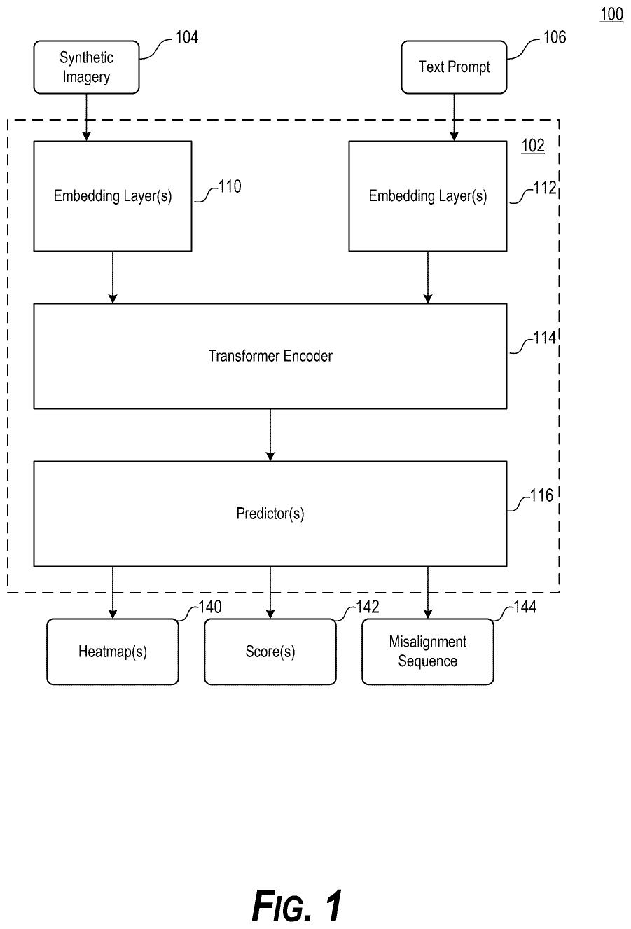

FIG. 1 is a block diagram depicting an example computing environment 100 including a machine-learned multimodal feedback prediction model 102 in accordance with example embodiments of the present disclosure.

Machine-learned multimodal model 102 can be configured to receive imagery and text as input and output one or more predictions. For example, machine learned multimodal model 102 can be configured to receive imagery such as synthetic imagery 104 and text 106 as input and output one or more predicted aspects of the imagery such as one or more heatmaps 140 (e.g., implausibility/misalignment heatmaps), one or more scores 142 (e.g., plausibility, alignment, aesthetics, overall), and/or one or more misalignment sequences 144 (e.g., misaligned keyword sequences). For instance, model 102 can take an image such as a natural image, a web page, a mobile interface, a graphic design image, a video, or any other suitable type of image along with a text prompt as input and generate predictions such as heatmaps, scores, and misaligned keyword sequences. The text prompt can include an indication of the prediction to be generated such as a request for a misalignment heatmap, an alignment score, and/or a misaligned keyword sequence.

Model 102 can include a multimodal encoder-decoder transformer architecture that is configured to unify various modeling tasks. Model 102 can include one or more image embedding layers 110 for image encoding, one or more text embedding layers 112 for text embedding, and a transformer encoder 114 to fuse image and text representations. The one or more image embedding layers 110 can include one or more machine-learned vision embedding layers and the one or more text embedding layers 112 can include one or more machine-learned word embedding layers. For example, the one or more image embedding layers 110 can include a vision transformer and the one or more text embedding layers 112 can include a word embedding layer. Model 102 can include one or more predictors 116 configured to generate a variety of different predictions such as, for example, an implausibility/misalignment heatmap, a plausibility, alignment, aesthetics or overall score, and a misaligned keyword sequence. The text input 106 for the machine-learned multimodal model 102 can be designed to encode relevant information about the input domain (e.g., natural image, graphic design, web page, etc.), the expected prediction type (e.g., heatmaps, scores, misalignment sequences, etc.) of the model 102, and task-related information such as viewing scenarios (e.g., free-viewing, object-searching), target object names, or questions to be answered.

Model 102 can be pretrained on natural images and mobile UI image datasets in example embodiments. This pretraining can enable the model to generalize to multiple domains. In an example aspect, image captioning and captioning for a screen region can be used as pretraining tasks. To support sequence tasks involving the prediction of gaze/interaction coordinates, such as scanpath prediction, pretraining tasks can be added to predict bounding box coordinates given a text snippet and a screenshot or screen region.

In some examples, computing environment 100 may be implemented as a client server computing environment, including one or more client computing devices implementing downstream applications and one or more server computing systems implementing multimodal model 102. In another example, one or more of the downstream applications can be implemented at a server computing system.

In some examples, computing environment 100 may be implemented as a client server computing environment, including one or more client computing devices implementing downstream applications and one or more server computing systems implementing multimodal model 102. In another example, one or more of the downstream applications can be implemented at a server computing system.

The computing systems implementing multimodal model 102 and downstream applications can be connected by and communicate through one or more networks (not shown). Any number of client computing devices and/or server computing devices can be included in the client-server environment and communicate over a network. The network can be any type of communications network, such as a local area network (e.g., intranet), wide area network (e.g., Internet), or some combination thereof. In general, communication between the computing devices can be carried via a network interface using any type of wired and/or wireless connection, using a variety of communication protocols (e.g., TCP/IP, HTTP, RTP, RTCP, etc.), encodings or formats (e.g., HTML, XML, etc.), and/or protection schemes (e.g., VPN, secure HTTP, SSL, etc.).

In some example embodiments, a client computing device implementing a downstream application can be any suitable device, including, but not limited to, a smartphone, a tablet, a laptop, a desktop computer, or any other computer device that is configured such that it can allow a user to access remote computing devices over a network. The client computing devices can include one or more processor(s), memory, and a display as described in more detail hereinafter. The client computing devices can execute one or more client applications such as a web browser, email application, chat application, video conferencing application, word processing application or the like.

The server computing system can include one or more processor(s) and memory implementing multimodal model 102. Multimodal model 102 can be implemented as part of a machine-learning system. The server computing system can be in communication with the one or more client computing device(s) using a network communication device that is not pictured.

It will be appreciated that the term “system” can refer to specialized hardware, computer logic that executes on a more general processor, or some combination thereof. Thus, a system can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

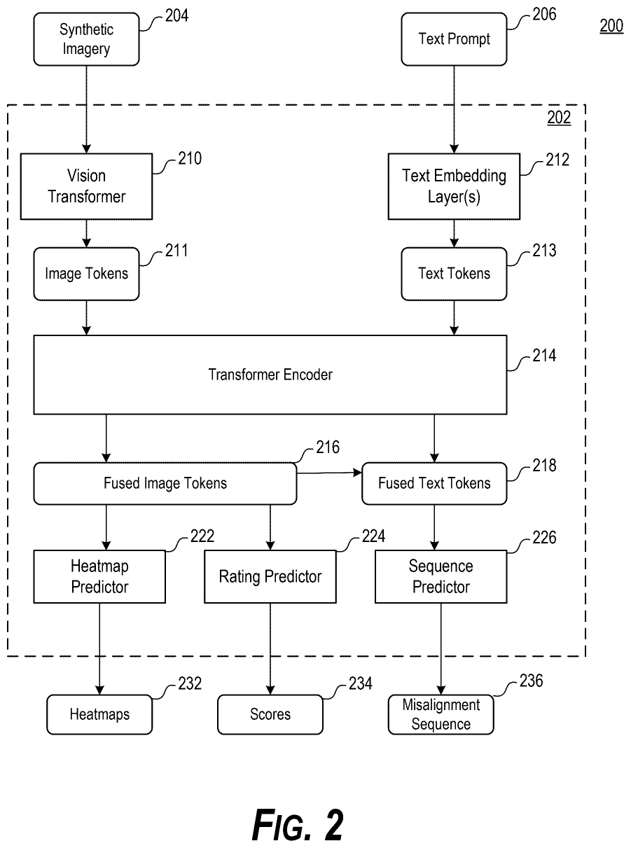

FIG. 2 is a block diagram depicting an example computing environment 200 including a machine-learned multimodal feedback prediction model 202 in accordance with example embodiments of the present disclosure. Machine-learned multimodal model 202 is an example of machine-learned multimodal model 102 in FIG. 1. Machine-learned multimodal model 202 can be configured to receive synthetic imagery 204 and a text prompt 206 as input and generate outputs including heatmaps 232, scores 234, and misalignment sequences 236.

Model 202 can include a multimodal encoder-decoder transformer architecture including a vision transformer that is configured to receive imagery 204 and generate one or more image encodings such as image tokens 211. Model 202 includes one or more text embedding layers 212 such as word embedding layers that are configured to receive the text prompt 206 and generate one or more text encodings such as text tokens 213. Transformer encoder 214 can be configured to receive the image tokens 211 and text tokens 213 and generate one or more fused image tokens 216 and one or more fused text tokens. Transformer encoder 214 can include a self-attention module among the concatenated image tokens and text tokens to facilitate bidirectional information propagation. The text information can be propagated to text tokes for better vision-aware text encoding to decode the misalignment sequence. To pretrain the model on more diverse images, a natural image captioning task on a large-scale image dataset can be added to the pretraining task mixture.

Vision transformer 210 can receive a generated or synthetic image 208 and generate an output including image tokens 211 as high-level representations. The text prompt tokens can be embedded into dense vectors. The image tokens 211 and text tokens 213 can be concatenated and encoded through transformer self-attention encoder 214 to generate fused image token(s) 216 and fused text token(s) 217.

Model 202 can include multiple types of predictors to predict different outputs. In an example implementation, model 202 includes an implausibility/misalignment heatmap predictor 222 that generates heatmaps 232 (e.g., implausibility heatmaps and misalignment heatmaps), a rating predictor 224 (also referred to as a score predictor) that generates plausibility, alignment, aesthetics, and/or overall scores, and a sequence predictor 226 that is configured to predict keyword misalignment sequences 236.

For heatmap prediction, the image tokens 211 can be reshaped into a feature map and sent through one or more convolution layers, one or more deconvolution layers, and sigmoid activation of heatmap predictor 222. Heatmap predictor 222 can output implausibility and/or misalignment heatmaps 232.

For score prediction, the fused text tokens 217 can be reshaped into feature maps and sent through convolution layer(s), linear layers, and sigmoid activation, resulting in scalars as fine-grained scores for plausibility, alignment, aesthetics, and/or overall image quality.

To predict a keyword misalignment sequence, the original prompt used to generate the synthetic image can be used as text input to the model. A modified prompt can be used as the prediction target for the decoder. The modified prompt can include a special suffix (e.g., ‘0’) for each misaligned token. For example, a yellow_0 cat can be used if the generated image contains a black cat and the word yellow is misaligned with the image. During evaluation, the misaligned keywords can be extracted using the special suffix.

Various model variants can be utilized for the prediction heatmaps and scores.

In a multi-head configuration of the multimodal model, a separate prediction head can be used for each output prediction type including each prediction score type, each heatmap type, and each misaligned keyword sequence type. For example, seven prediction heads may be used to provide an implausibility heatmap, a misalignment heatmap, a plausibility score, an alignment score, an aesthetics score, an overall image quality score, and a keyword misalignment sequence. In another approach, a single head can be used for each prediction type. For example, a single head (e.g., a single prediction head) can be used to generate the different heatmap prediction types, a single head can be used to generate the different score types, and a single head can be used to generate misalignment sequences. An input prompt can be augmented with the prediction output type to cause the model prediction head to generate a particular prediction. A task string can be prepended to an input text prompt for each particular task. The corresponding label can be used as a training target. During inference, by augmenting the prompt with the corresponding task string, a single prediction head can generate different prediction types. For example, the task string “implausibility heatmap” can be prepended to an input prompt to cause the heatmap prediction head to generate an implausibility heatmap. The task string “alignment score” can be prepended to an input prompt to cause the rating prediction head to generate an alignment score. In this manner, an augmented prompt approach can create task-specific vision feature maps and text encodings.

In example embodiments, the multimodal model 202 can be trained with a pixel-wise mean squared error (MSE) loss for the heatmap prediction, and MSE loss for the score prediction. For misalignment sequence prediction, the model can be trained with teacher-forcing cross entropy loss. The final loss function can be the weighted combination of the heatmap MSE loss, the score MSE loss, and the sequence teacher-forcing cross-entropy loss.

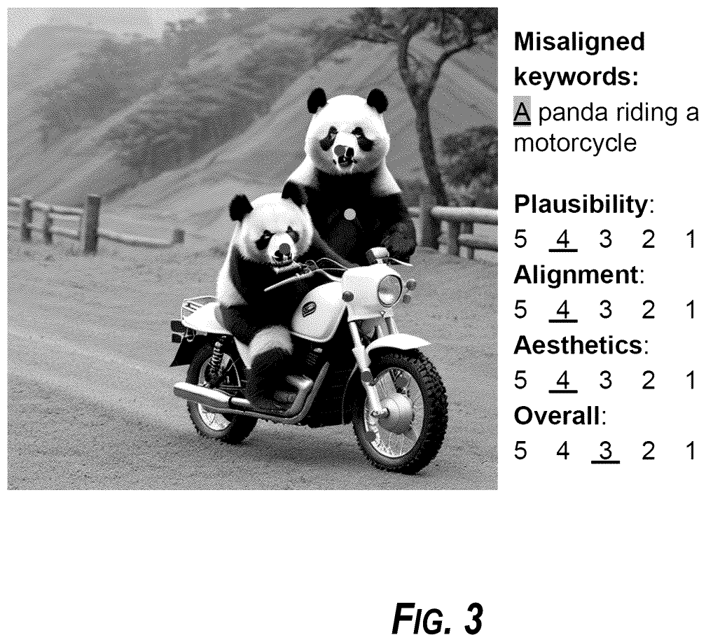

FIG. 3 is a block diagram depicting an example user interface for collecting rich human feedback for a synthetically generated image in accordance with example embodiments of the present disclosure. An example procedure is designed to collect a dataset which includes two heatmaps (e.g., an implausibility heatmap and misalignment heatmap), a set of fine-grained image quality scores (e.g., a plausibility score, an aesthetics score, an alignment score, and an overall image quality (i.e., ‘goodness’) score), and a keyword misalignment sequence.

For a synthetically generated image, the interface enables annotators to examine the generated image and the text prompt and provide human feedback. For example, annotation interface 300 can provide an example synthetic image 302 and a text prompt 304 from which the synthetic image was generated. Annotation interface 300 can facilitate the receipt of rich human feedback at inputs 305. For example, annotation interface 300 can facilitate the receipt of inputs from annotators that mark locations in the image that contain implausibility/artifact regions or misalignments with respect to the text prompt. Each marked point can have an effective radius (e.g., 1/20th of the image height) which forms an imaginary disk centered at the marked point. In this manner, a relatively small amount of points can be used to cover the image region with flaws. Annotation interface 300 can also facilitate the receipt of inputs from annotators that label misaligned keywords in the input text prompt. Additionally, annotation interface 300 can facilitate the receipt of inputs from annotators that provide a plausibility score, a text-image misalignment score, an aesthetic score, and an overall quality score such as a score from 1-5. For example, a scale 1-5 can be used. Annotation interface 300 can include a web user interface to facilitate data collection.

To improve the reliability of the collected human feedback, each image can be annotated by multiple annotators (e.g., three). The multiple annotations for each sample can be consolidated. For the scores in an example implementation, an average of the scores from the multiple annotators is used to improve the reliability and quality of the scores. For the misaligned keyword sequences, majority voting can be used to get the final sequence of indicators of aligned/misaligned, using the most frequent label for the keywords. For the point annotations, the annotations can be converted to a disk region on the heatmap, and then the average heatmap can be computed across annotations. The regions with clear implausibility are likely to be annotated by all annotators and have a high value on the final average heatmap.

As a specific example, a subset of image-text pairs can be selected for data annotation. Although the disclosed method is general and applicable to any generated images, a majority of the dataset is chosen to be photo-realistic images, due to their importance and wider applications. Moreover, a balanced distribution of categories across the images is sought. To ensure balance, a visual question answering (VQA) model is utilized to extract some basic features from the data samples. Specifically, the following questions are asked for each image-text pair: 1) Is the image photorealistic? 2) Which category best describes the image? Choose one in ‘human’, ‘animal’, ‘object’, ‘indoor scene’, ‘outdoor scene’. The answers to these two questions are generally reliable under manual inspection. The answers are used to sample a diverse subset, resulting in 17K image-text pairs. The 17K samples are randomly split into two subsets, a training set with 16K samples and a validation set with 1K samples. The distribution of the attributes of the 16K training samples is shown in the supplementary materials. Additionally, rich human feedback is collected on the unique prompts and their corresponding images from a test set to form another test set. In total, rich human feedback is collected on 18K image-text pairs. The resulting dataset consists of 16K training, 1K validation, and 1K test samples.

The statistics of the scores and the annotator agreement analysis for the scores can vary by implementation. In an example implementation, the scores are standardized using the formula (s−smin)/(smax−smin) (where smax=5 and smin=1) to ensure they fall within the range [0, 1].

Histogram plots of the scores can be provided. The distribution of the scores generally approximates a Gaussian distribution, although plausibility and text-image alignment scores exhibit a slightly higher percentage at 1.0. The distribution of the collected scores provides a sufficient number of negative and positive samples for training an effective reward model.

To analyze rating agreement among annotators for an image-text pair, the maximum difference among the scores is calculated as: maxdiff=max (scores)—min (scores), where scores represent the three score labels for an image-text pair. A histogram of maxdiff can be provided. Approximately 25% of the samples demonstrate perfect annotator agreement, and approximately 85% of the samples show good annotator agreement (where maxdiff is less than or equal to 0.25 after standardization, or 1 on the 5-point Likert scale).

### Example Methods

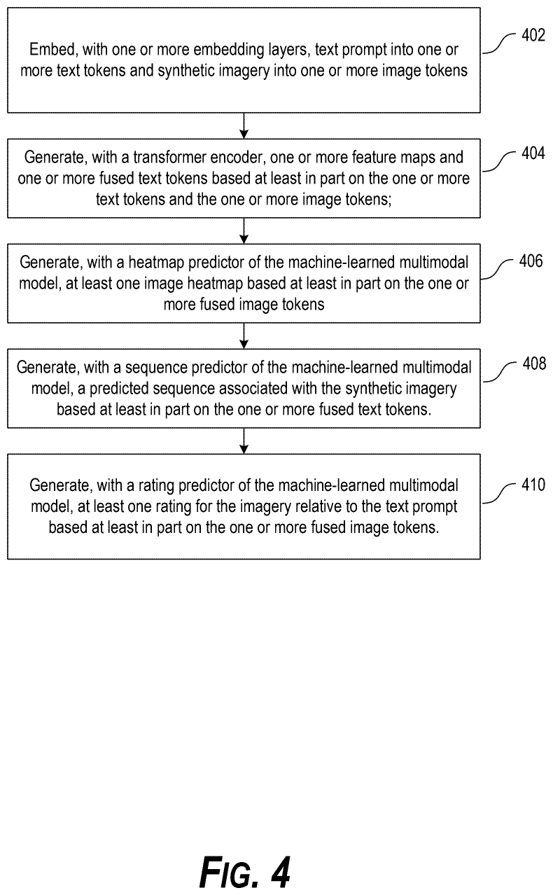

FIG. 4 is a flowchart diagram depicting an example method for generating one or more feedback predictions with a machine-learned multimodal model in accordance with an example embodiment of the present disclosure. One or more portion(s) of example method 400 and the other methods described herein can be implemented by a computing system that includes one or more computing devices such as, for example, computing systems described with reference to the other figures. Each respective portion of the example methods can be performed by any (or any combination) of one or more computing devices. Moreover, one or more portion(s) of the example methods can be implemented on the hardware components of the device(s) described herein, for example, to train one or more systems or models. The methods in the figures may depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The example methods are described with reference to elements/terms described with respect to other systems and figures for exemplary illustrated purposes and is not meant to be limiting. One or more portions of the example methods can be performed additionally, or alternatively, by other systems.

At 402, example method 400 can include embedding, with one or more embedding layers of a multimodal machine-learned model, a text prompt into one or more text tokens and synthetic imagery into one or more image tokens. The embedding layers include specialized components, such as one or more image embedding layers (e.g., a vision transformer) for processing the visual input and one or more text embedding layers (e.g., a word embedding layer) for handling the textual input. These layers are configured to transform the raw imagery into a set of image tokens and the input text into a set of text tokens. This process involves breaking down the input data into fundamental units or “tokens” (e.g., image patches for imagery, or words/sub-word units for text) and then converting these tokens into a numerical representation within a high-dimensional embedding space, making them compatible for further processing by the machine-learned model.

At 404, example method 400 can include generating, with a transformer encoder of the multimodal machine-learned model, one or more feature maps (e.g., fused image tokens) and one or more fused text tokens based at least in part on the one or more text tokens and the one or more image tokens. The transformer encoder can include a component of a transformer model configured to process sequences of input data. It can employ a self-attention mechanism to weigh the significance of different portions of the input data relative to each other, thereby capturing long-range dependencies and contextual relationships within and across the input sequences. Fused image tokens can include a numerical representation of image data that has been combined or integrated with information from text data. Similarly, fused text tokens can include a numerical representation of text data that has been combined or integrated with information from image data. These fused tokens can be generated by the transformer encoder, which receives both the one or more image tokens (representing the visual input) and the one or more text tokens (representing the textual input). The transformer encoder processes these distinct token types together, allowing the self-attention mechanism to establish relationships and synthesize information between the visual and textual modalities. This integration process results in the fused image and text tokens, which encapsulate a combined understanding derived from both input modalities.

At 406, example method 400 can include generating, with a heatmap predictor of the multimodal machine-learned model, at least one image heatmap based at least in part on the one or more fused image tokens. The heatmap predictor can generate a variety of heatmap types, including implausibility heatmaps and misalignment heatmaps. Implausibility heatmaps can indicate regions including distortions (e.g., distorted human/animal bodies/faces, missing/additional parts, distorted objects, distorted/nonsensical text, nonsensical representations, excessive blurriness/lack of sharpness that detracts from the overall image, other artifacts or implausibility). Misalignment heatmaps can indicate regions including a missing object/human/animal, an incorrect attribute (e.g., color), or an incorrect action (e.g., an action in the prompt not represented in the image), incorrect numbers of humans/objects/animals, incorrect positions, or other inconsistencies between the text and image.

At 408, example method 400 can include generating, with a sequence predictor of the multimodal machine-learned model, at least one predicted sequence based at least in part on the one or more fused text tokens. The predicted sequences can include words or phrases of the textual input that are predicted to be missing or misaligned with the generated image. To predict the keyword misalignment sequence, the original prompt used to generate the synthetic image can be used as text input to the model. A modified prompt can be used as the prediction target for the decoder. The modified prompt can include a special suffix (e.g., ‘_0’) for each misaligned token. For example, a yellow_0 cat can be used if the generated image contains a black cat and the word yellow is misaligned with the image. During evaluation, the misaligned keywords can be extracted using the special suffix.

At 410, example method 400 can include generating, with a rating predictor of the multimodal machine-learned model, at least one rating for the imagery relative to the text prompt based at least in part on the one or more fused text tokens. The at least one rating can include at least one fine-grained image score based at least in part on the one or more fused text tokens. A number of ratings can be generated, including a plausibility score, an alignment score, an aesthetics score, an overall image quality score, or other scores. The feature map can be sent through convolution layer(s), linear layers, and sigmoid activation, resulting in scalars as fine-grained scores for plausibility, alignment, aesthetic, and overall image quality.

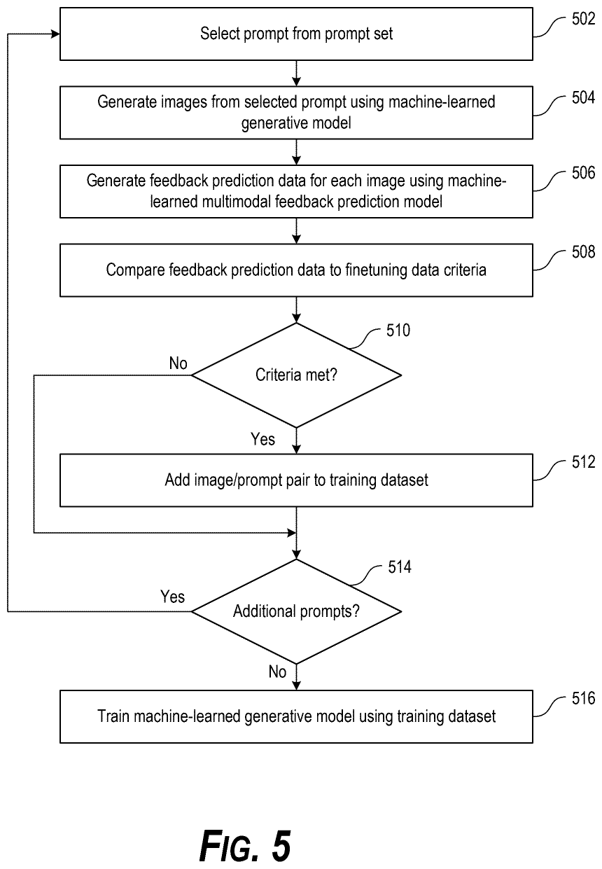

FIG. 5 is a flowchart diagram depicting an example method for generating feedback predictions with a machine-learned multimodal model and training a machine-learned generative model using the feedback predictions according to example embodiments of the present disclosure.

FIG. 5 is a flowchart diagram depicting an example method 500 for generating feedback predictions with a machine-learned multimodal model and training a machine-learned generative model using the feedback predictions according to example embodiments of the present disclosure. Finetuning with rich automatic human feedback scores can be used to improve the generative model.

At 502, example method 500 can include selecting a prompt from a prompt set.

At 504, example method 500 can include generating, with a machine-learned generative model, synthetic imagery in response to the prompt.

At 506, example method 500 can include generating feedback prediction data for each synthetic image using a machine-learned multimodal feedback prediction model. The feedback prediction data can include a rich automatic human feedback score for each synthetically generated image.

At 508, example method 500 can include comparing the feedback prediction data for the synthetic images to finetuning data criteria. In an example, the scores for each image from a prompt can be compared to a fixed threshold.

At 510, example method 500 can include determining whether the feedback prediction data meets or otherwise satisfies the finetuning data criteria. In an example, if the highest score for the images from the prompt is above the threshold, the prompt can be selected as part of the finetuning dataset.

If the feedback prediction data meets or otherwise satisfies the finetuning criteria, method 500 can continue at 512. Otherwise, method 500 can continue at 514.

At 512, example method 500 can include adding the image/prompt pair to the training dataset.

At 514, example method 500 can include determining whether there are additional prompts to select from the prompt set.

If there are additional prompts, method 500 can continue at 502. Otherwise, method 500 can continue at 516.

At 516, example method 500 can include training the machine-learned generative model with the training dataset.

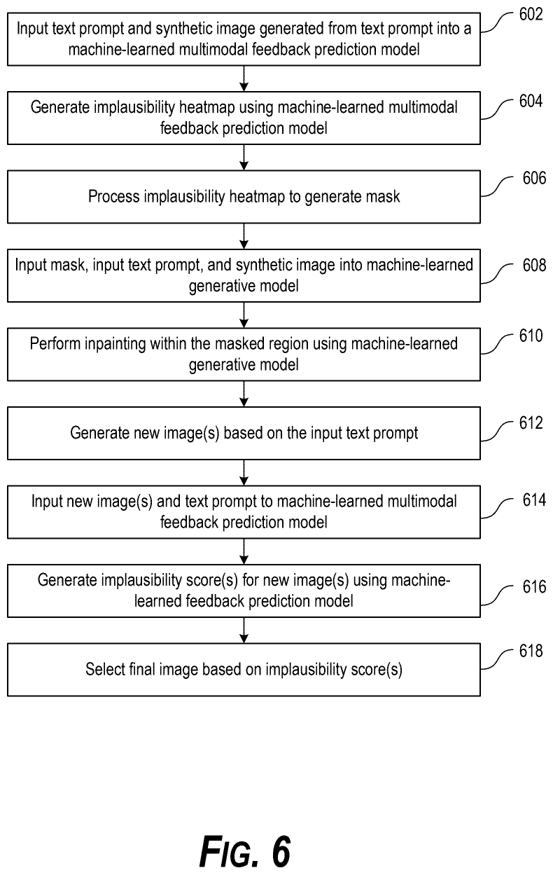

FIG. 6 is a flowchart diagram depicting an example method for generating feedback predictions with a machine-learned multimodal model and performing region inpainting on synthetic images based on the feedback predictions according to example embodiments of the present disclosure.

At 602, example method 600 can include inputting a text prompt and a synthetic image generated from the text prompt using a machine-learned generative model into a machine-learned multimodal feedback prediction model.

At 604, example method 600 can include generating an implausibility heatmap with the machine-learned multimodal feedback prediction model.

At 606, example method 600 can include processing the implausibility heatmap to generate one or more masks. The heatmap can be processed using thresholding and dilating.

At 608, example method 600 can include inputting the mask, the input text prompt, and the synthetic image into the machine-learned generative model.

At 610, example method 600 can include performing inpainting within the masked regions of the input image in response to the mask. Inpainting can be performed using the machine-learned generative model.

At 612, example method 600 can include generating one or more new synthetic images based on the inpainting.

At 614, example method 600 can include inputting the new synthetic image(s) and the text prompt to the machine-learned multimodal feedback prediction model.

At 616, example method 600 can include generating one or more implausibility scores for the new synthetic images using the machine-learned multimodal feedback prediction model.

At 618, example method 600 can include selecting a final image based on the implausibility score(s).

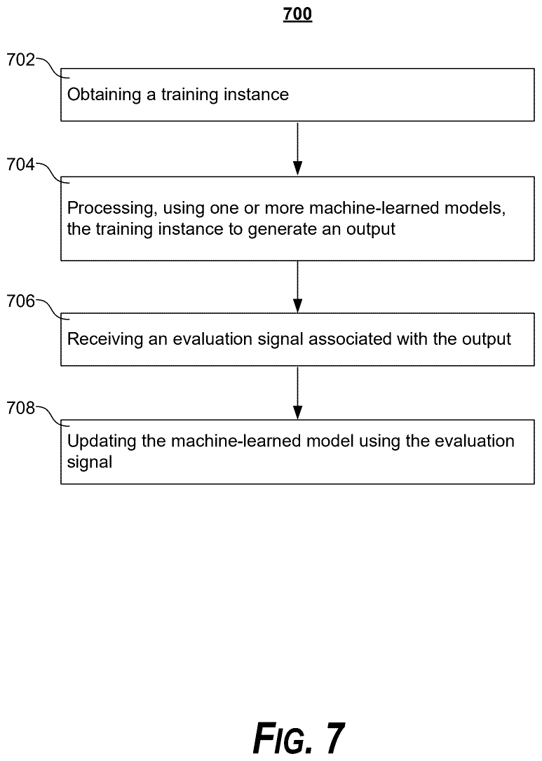

FIG. 7 depicts a flowchart of a method 700 for training one or more machine-learned models according to aspects of the present disclosure. For instance, an example machine-learned model can include a core sequence processing model such as a foundational large language model (LLM) or image-to-text model.

One or more portion(s) of example method 700 can be implemented by a computing system that includes one or more computing devices such as, for example, computing systems described with reference to the other figures.

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types. In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

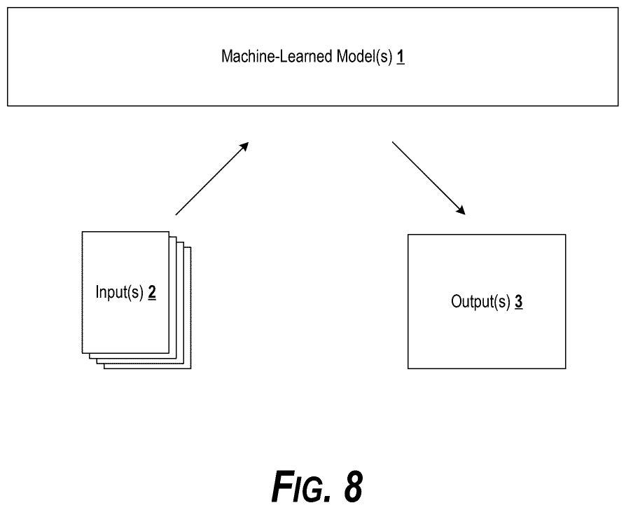

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

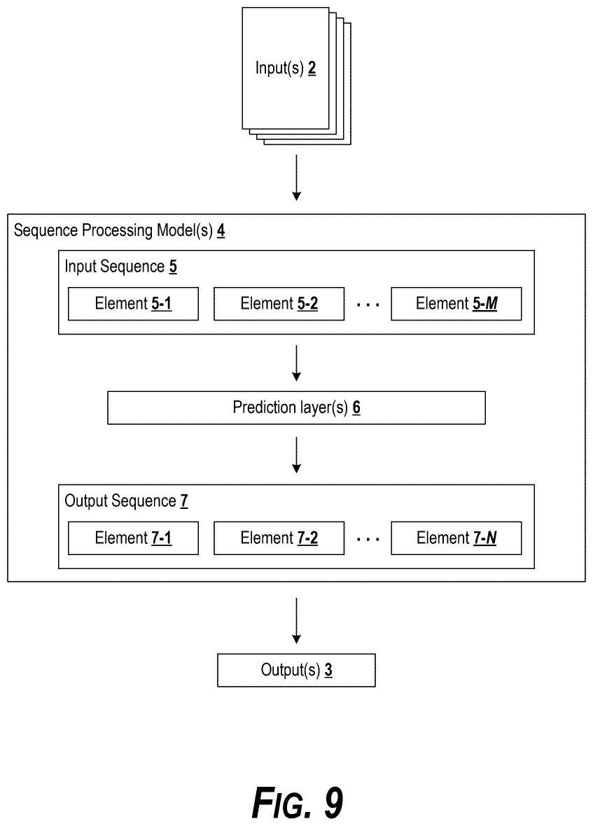

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

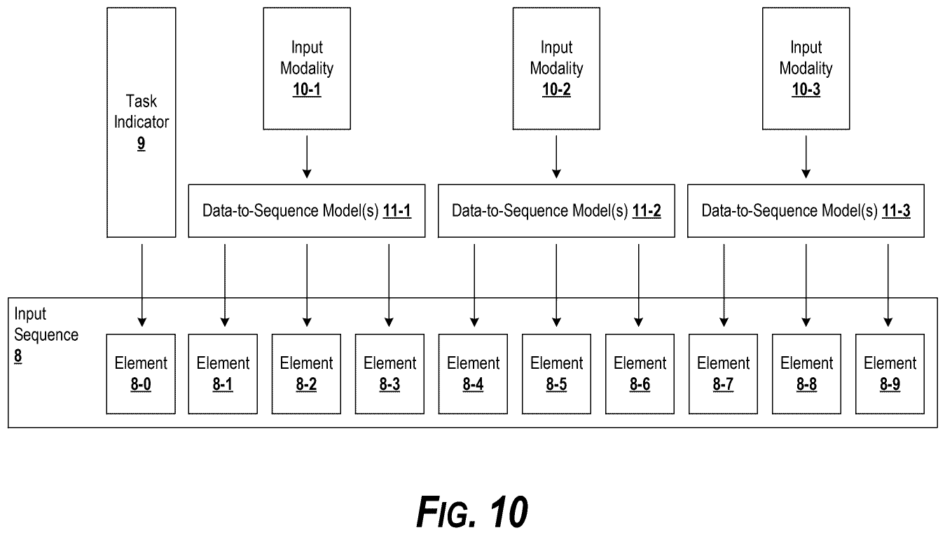

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

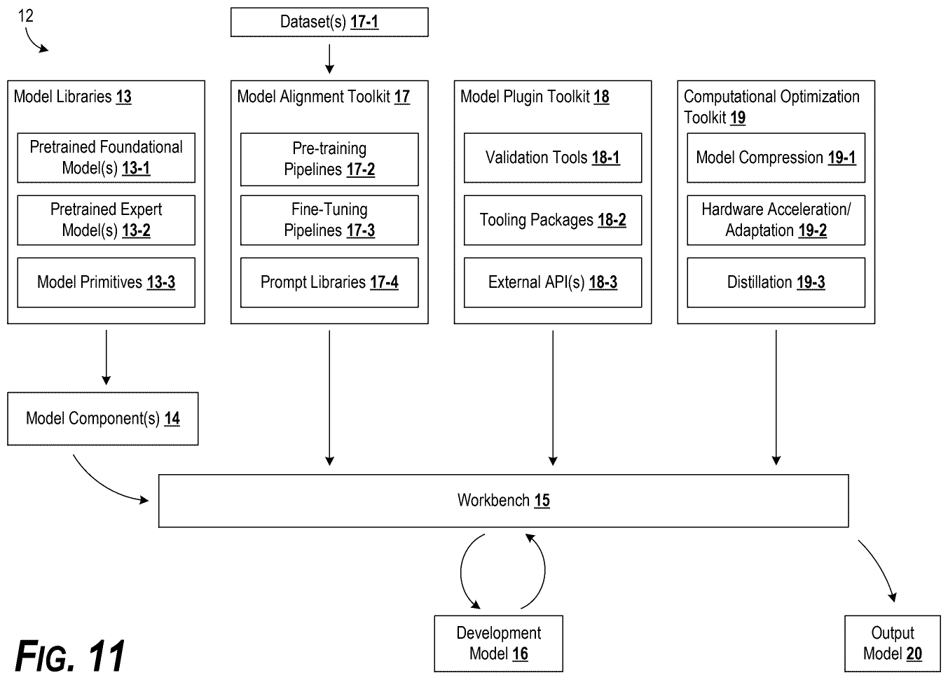

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

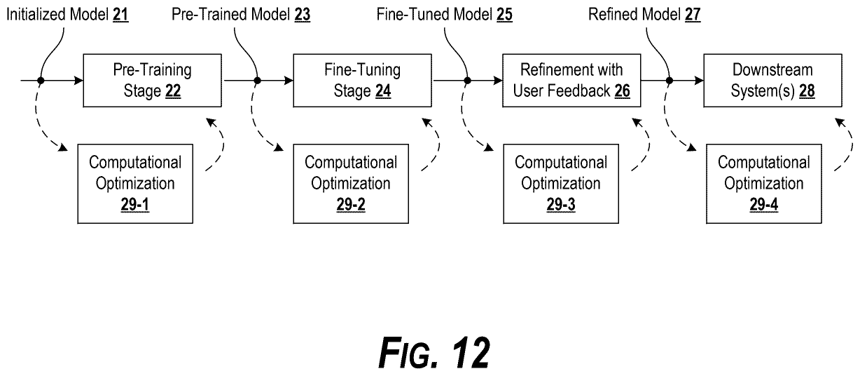

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

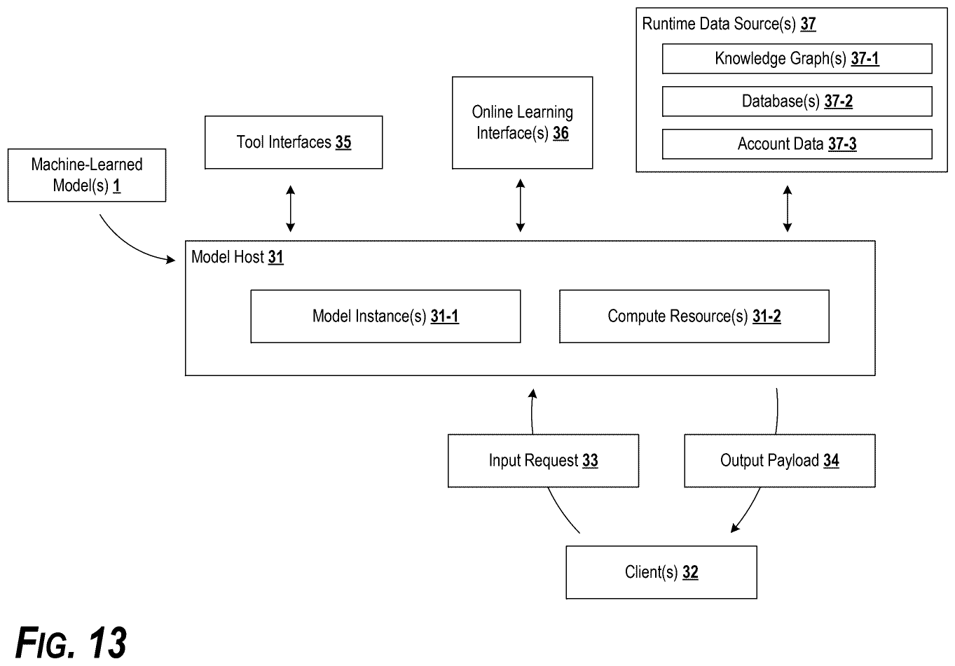

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

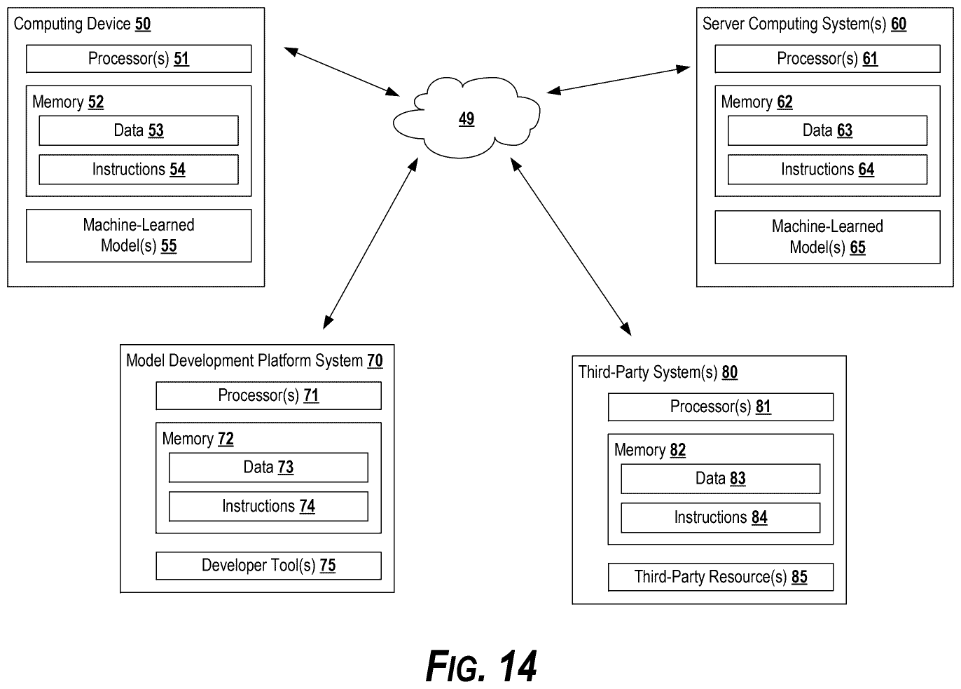

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

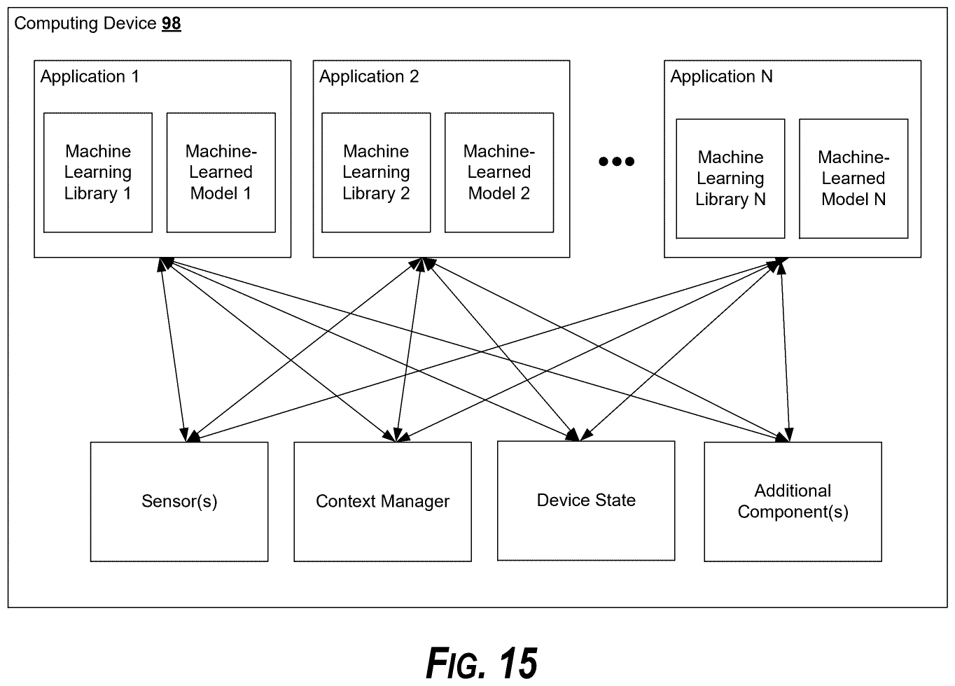

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model.

Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

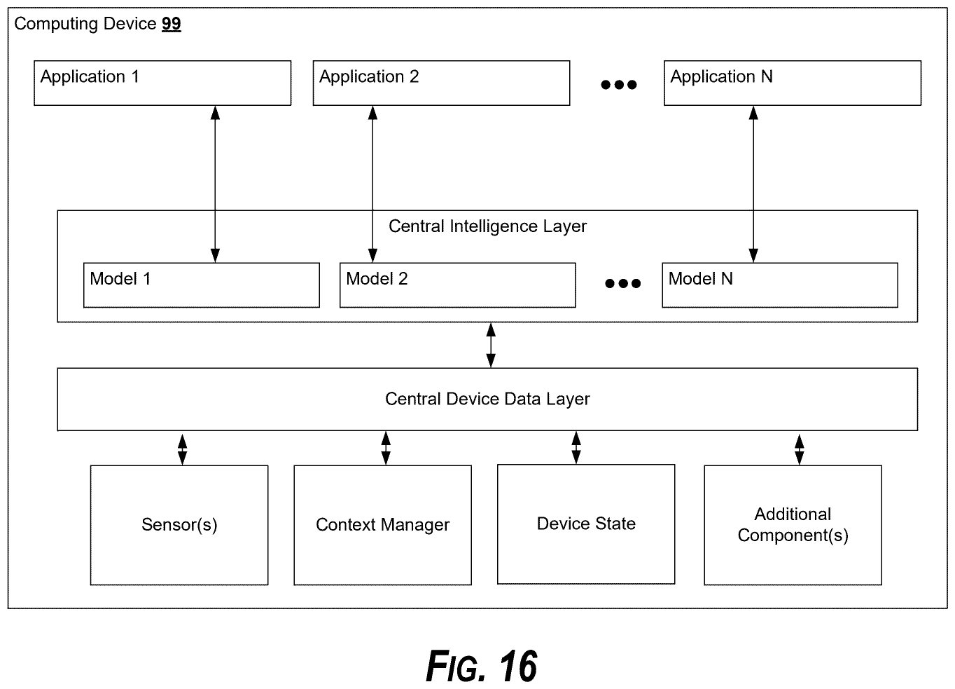

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 16, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

Additional details regarding aspects of the present disclosure can be found in the attached Appendix A.

What is claimed is:

1. A computer-implemented method, comprising, by a computing system including one or more computing devices:
obtaining a text prompt and a synthetic image generated by a machine-learned generative model in response to the text prompt;
generating, with a machine-learned multimodal model, at least one feature map based at least in part on fusion of image information and text information from the synthetic image and the text prompt;
generating, with the machine-learned multimodal model, a set of text tokens based at least in part on fusion of the image information and the text information;
generating, with the machine-learned multimodal model, at least one image heatmap based at least in part on the at least one feature map, the at least one image heatmap including at least one of a misalignment heatmap or an implausibility heatmap; and
generating, with the machine-learned multimodal model, at least one predicted misalignment sequence based at least in part on the set of text tokens.

2. The computer-implemented method of claim 1, further comprising:
generating a set of image tokens based at least in part on fusion of the image information and the text information.

3. The computer-implemented method of claim 2, wherein:
generating the at least one feature map based at least in part on fusion of the image information and the text information comprises generating the at least one feature map based at least in part on the set of image tokens.

4. The computer-implemented method of claim 2, wherein:
generating the at least one predicted misalignment sequence comprises generating the at least one predicted misalignment sequence based at least in part on the set of text tokens and the set of image tokens.

5. The computer-implemented method of claim 1, further comprising:
generating, with the machine-learned multimodal model, at least one score based at least in part on the at least one feature map.

6. The computer-implemented method of claim 5, further comprising:
adding the synthetic image and the text prompt to a training dataset in response to the at least one score satisfying one or more criteria.

7. The computer-implemented method of claim 6, further comprising:
training the machine-learned generative model based at least in part on the training dataset including the synthetic image and the text prompt.

8. The computer-implemented method of claim 6, wherein:
the machine-learned generative model is a first machine-learned generative model; and
the method further comprises:
training a second machine-learned generative model based at least in part on the synthetic image and the text prompt.

9. The computer-implemented method of claim 1, further comprising:
generating at least one image mask based at least in part on the at least one image heatmap; and
performing image inpainting within at least one region of the image based at least in part on the at least one image mask.

10. The computer-implemented method of claim 1, wherein:
the machine-learned multimodal model includes a transformer self-attention encoder.

11. The computer-implemented method of claim 1, wherein:
the set of text tokens is a second set of text tokens; and
the machine-learned multimodal model includes:
one or more embedding layers configured to generate a set of image tokens and a first set of text tokens in response to the synthetic image and the text prompt; and
a transformer encoder configured to receive the set of image tokens and the first set of text tokens and generate the at least one feature map and the second set of text tokens.

12. The computer-implemented method of claim 11, wherein the machine-learned multimodal model includes:
a heatmap prediction head configured to obtain the at least one feature map and generate the at least one image heatmap; and
a sequence prediction head configured to obtain the second set of text tokens and generate a keyword misalignment sequence associated with the synthetic image and the text prompt.

13. The computer-implemented method of claim 12, wherein the machine-learned multimodal model includes:
at least one rating prediction head configured to obtain the at least one feature map and generate at least one of a plausibility score, an alignment score, an aesthetics score, or an overall image score.

14. A computing system, comprising:
one or more processors; and
one or more computer-readable storage media that store instructions that, when executed by the one or more processors, cause the one or more processors to perform operations, the operations comprising:
obtaining a text prompt and a synthetic image generated by a machine-learned generative model in response to the text prompt;
generating, with a machine-learned multimodal model, at least one feature map based at least in part on fusion of image information and text information from the synthetic image and the text prompt;
generating, with the machine-learned multimodal model, a set of text tokens based at least in part on fusion of the image information and the text information;
generating, with the machine-learned multimodal model, at least one image heatmap based at least in part on the at least one feature map, the at least one image heatmap including at least one of a misalignment heatmap or an implausibility heatmap; and
generating, with the machine-learned multimodal model, at least one predicted misalignment sequence based at least in part on the set of text tokens.

15. The computing system of claim 14, wherein the operations further comprise:
generating, with the machine-learned multimodal model, at least one score based at least in part on the at least one feature map; and
adding the synthetic image and the text prompt to a training dataset in response to the at least one score satisfying one or more criteria.

16. The computing system of claim 15, wherein the operations further comprise:
training the machine-learned generative model based at least in part on the training dataset including the synthetic image and the text prompt.

17. The computing system of claim 14, wherein the operations further comprise:
generating at least one image mask based at least in part on the at least one image heatmap; and
performing image inpainting within at least one region of the image based at least in part on the at least one image mask.

18. One or more non-transitory computer-readable storage media that store instructions that, when executed by one or more processors, cause the one or more processors to perform operations, the operations comprising:
obtaining a text prompt and a synthetic image generated by a machine-learned generative model in response to the text prompt;
generating, with a machine-learned multimodal model, at least one feature map based at least in part on fusion of image information and text information from the synthetic image and the text prompt;
generating, with the machine-learned multimodal model, a set of text tokens based at least in part on fusion of the image information and the text information;
generating, with the machine-learned multimodal model, at least one image heatmap based at least in part on the at least one feature map, the at least one image heatmap including at least one of a misalignment heatmap or an implausibility heatmap; and
generating, with the machine-learned multimodal model, at least one predicted misalignment sequence based at least in part on the set of text tokens.

19. The one or more non-transitory computer-readable storage media of claim 18, wherein the operations further comprise:
generating, with the machine-learned multimodal model, at least one score based at least in part on the at least one feature map;
adding the synthetic image and the text prompt to a training dataset in response to the at least one score satisfying one or more criteria; and
training the machine-learned generative model based at least in part on the training dataset including the synthetic image and the text prompt.

20. The one or more non-transitory computer-readable storage media of claim 18, wherein the operations further comprise:
generating at least one image mask based at least in part on the at least one image heatmap; and
performing image inpainting within at least one region of the image based at least in part on the at least one image mask.
